(19) United States
(12) Patent Application Publication
(10) Pub. No.: US 2026/0236284 A1
(43) Pub. Date: Aug. 13, 2026

(54) METHOD AND SYSTEM FOR MANAGING EXECUTION OF INSTANCES IN A COMPUTING ENVIRONMENT

(71) Applicant: JPMorgan Chase Bank, N.A., New York, NY (US)

(72) Inventors: Jitesh PARMAR, Mumbai Suburban (IN); Niti SHAH, Mumbai (IN); Alistair BARETTO, Thane (IN); Charmi KHAMBHATI, Ankleshwar (IN); Geeta SUVARNA, Mumbai (IN); Amit CHITRODE, Indore (IN); Shailesh PANDEY, Mumbai (IN)

(73) Assignee: JPMorgan Chase Bank, N.A., New York, NY (US)

(21) Appl. No.: 19/172,233

(22) Filed: Apr. 7, 2025

(30) Foreign Application Priority Data
Feb. 13, 2025 (IN) 202511012246

(51) Int. Cl. G06F 9/455; G06F 9/50

(52) U.S. Cl. CPC G06F 9/45533; G06F 9/5077

(57) ABSTRACT

A method and system for managing execution of instances in a computing environment are disclosed. The method includes collecting a set of data associated with a plurality of instances for a predefined period, from a plurality of sources. The method also includes identifying a historical usage of the plurality of instances based on an analysis of the set of data. The method also includes generating, using a trained model, a set of configurations for at least one instance from the plurality of instances based on the identified historical usage in accordance with a set of predefined criteria. Thereafter, the method includes executing at least one instance based on the set of configurations for managing the at least one instance in the computing environment.

### CROSS-REFERENCE TO RELATED APPLICATIONS

This application claims priority benefit from Indian Application No. 202511012246, filed on Feb. 13, 2025, in the India Patent Office, which is hereby incorporated by reference in its entirety.

### FIELD OF THE DISCLOSURE

This technology generally relates to cloud computing, and more particularly relates to a method and system for managing execution of instances in a computing environment.

### BACKGROUND INFORMATION

The following description of the related art is intended to provide background information pertaining to the field of the disclosure. This section may include certain aspects of the art that may be related to various features of the present disclosure. However, it should be appreciated that this section is used only to enhance the understanding of the reader with respect to the present disclosure, and not as admissions of the prior art.

In modern cloud-based applications, managing computing resources or instances efficiently across multiple environments such as development (Dev), quality assurance (QA), testing, and user acceptance testing (UAT), has become increasingly critical. However, the management of instances within these traditional environments presents technical problems, particularly in a landscape where teams are often distributed across different locations. Inefficient utilization of instances can hamper productivity and increase operational costs, including excessive use of electrical power. Electrical power demands for such operations are an industry wide problem, as illustrated by Microsoft recently leasing a nuclear power plant to provide electricity for its data processing operations.

Further, the management of instances across multiple environments is highly complex. Each environment often requires different configurations, resource allocations, and operational parameters. This complexity increases the likelihood of misconfigurations and inconsistencies, which can lead to errors during development and testing phases, ultimately affecting software quality. The additional testing to correct errors consumes computer resources, as well as electrical power.

The traditional approach often involves keeping all instances permanently active, leading to underutilization of computing power, increased expenditure, and resource management challenges. For instance, the QA team might only operate during standard business hours, while the UAT team may only require resources during specific testing phases. This creates a variable demand for resources that traditional management systems fail to address efficiently. Many organizations rely on some form of scheduling processes for provisioning and managing instances, which may be time-consuming and prone to error. The current automation processes (e.g., amazon web service (AWS®) compute Optimizer and AWS® light switch) such as scheduler apps for managing instances within an organization are not efficient and fail to stop unnecessary utilization of instances. Additionally, the current scheduling processes fail to estimate schedules for applications managed by different teams. Hence, existing processes of managing instances lead to inefficiencies and delays in deployment, as teams need to navigate through predefined workflows to start or shut down instances as needed.

Hence, in view of these and other existing limitations, there arises an imperative need to provide an efficient solution to overcome the above-mentioned limitations and to provide a method and system for managing efficient execution of instances in a computing environment that reduces testing and consumes less electrical power and computer resources.

### SUMMARY

The present disclosure, through one or more of its various aspects, embodiments, and/or specific features or sub-components, provides inter-aliases, various systems, servers, devices, methods, media, programs, and platforms for managing execution of instances in a computing environment.

According to an aspect of the present disclosure, a method for managing execution of instances in a computing environment is disclosed. The method is implemented by at least one processor. The method includes collecting, by the at least one processor, a set of data associated with a plurality of instances for a predefined period, from a plurality of sources. The method also includes identifying, by the at least one processor, a historical usage of the plurality of instances based on an analysis of the set of data. The method also includes generating, by the at least one processor using a trained model, a set of configurations for at least one instance from the plurality of instances based on the identified historical usage in accordance with a set of predefined criteria. Thereafter, the method includes executing, by the at least one processor, the at least one instance based on the set of configurations for managing at least one instance in the computing environment.

In accordance with an exemplary embodiment, the set of data may include at least one from among central processing unit usage reports, memory usage reports, shift details, a list of holidays, a code freeze period, and task descriptions.

In accordance with an exemplary embodiment, the historical usage of the plurality of instances may include a start time and an end time of each instance.

In accordance with an exemplary embodiment, the model may be trained based on the historical usage of the plurality of instances.

In accordance with an exemplary embodiment, the set of configurations may include at least one from among an estimated start time and an end time for the at least one instance, estimation of possible holidays and code freeze periods.

In accordance with an exemplary embodiment, the identified historical usage of the plurality of instances based on the analysis of the set of data may be a time series data used by the trained model to generate the set of configurations.

In accordance with an exemplary embodiment, the trained model may be integrated with a project management tool to evaluate an impacted set of instances from the plurality of instances.

In accordance with an exemplary embodiment, the set of configurations includes a start time and a stop time, and the executing the at least one instance further comprises for a particular instance starting the particular instance at the start time and stopping the particular instance at the stop time.

According to another aspect of the present disclosure, a computing device configured to implement an execution of a method for managing execution of instances in a computing environment is disclosed. The computing device includes a processor; a memory storing instructions; and a communication interface coupled to each of the processor and the memory. The processor may be programmed to cooperate with the instructions to perform operations including: collect a set of data associated with a plurality of instances for a predefined period from a plurality of sources. The processor may be further configured to identify a historical usage of the plurality of instances based on an analysis of the set of data; generate, using a trained model, a set of configurations for at least one instance from the plurality of instances based on the identified historical usage in accordance with a set of predefined criteria; and execute the at least one instance based on the set of configurations to manage the at least one instance in the computing environment.

In accordance with an exemplary embodiment, the set of data may include at least one from among central processing unit usage reports, memory usage reports, shift details, a list of holidays, a code freeze period, and task descriptions.

In accordance with an exemplary embodiment, the historical usage of the plurality of instances includes a start time and an end time of each instance.

In accordance with an exemplary embodiment, the model is trained based on the historical usage of the plurality of instances.

In accordance with an exemplary embodiment, the set of configurations includes at least one from among an estimated start time and an end time for the at least one instance, estimation of possible holidays and code freeze periods.

In accordance with an exemplary embodiment, the identified historical usage of the plurality of instances based on the analysis of the set of data may be a time series data used by the trained model to generate the set of configurations.

In accordance with an exemplary embodiment, the trained model may be integrated with a project management tool to evaluate an impacted set of instances from the plurality of instances.

In accordance with an exemplary embodiment, the set of configurations includes a start time and a stop time, and the execute the at least one instance further comprises for a particular instance starting the particular instance at the start time and stopping the particular instance at the stop time.

According to yet another aspect of the present disclosure, a non-transitory computer-readable storage medium storing instructions for managing execution of instances in a computing environment is disclosed. The instructions include executable code which, when executed by a processor, may cause the processor to perform operations including: collect a set of data associated with a plurality of instances for a predefined period from a plurality of sources; identify a historical usage of the plurality of instances based on analysis of the set of data; generate, using a trained model, a set of configurations for at least one instance from the plurality of instances based on the identified historical usage in accordance with a set of predefined criteria; and execute the at least one instance based on the set of configurations to manage the at least one instance in the computing environment.

In accordance with an exemplary embodiment, the set of data may include at least one from among central processing unit usage reports, memory usage reports, shift details, a list of holidays, a code freeze period, and task descriptions.

In accordance with an exemplary embodiment, the historical usage of the plurality of instances may include a start time and an end time of each instance.

In accordance with an exemplary embodiment, the model may be trained based on the historical usage of the plurality of instances.

In accordance with an exemplary embodiment, the set of configurations may include at least one from among an estimated start time and an end time for the at least one instance, estimation of possible holidays and code freeze periods.

In accordance with an exemplary embodiment, the identified historical usage of the plurality of instances based on the analysis of the set of data may be a time series data used by the trained model to generate the set of configurations.

In accordance with an exemplary embodiment, the trained model may be integrated with a project management tool to evaluate an impacted set of instances from the plurality of instances.

In accordance with an exemplary embodiment, the set of configurations includes a start time and a stop time, and the execute the at least one instance further comprises for a particular instance starting the particular instance at the start time and stopping the particular instance at the stop time.

### BRIEF DESCRIPTION OF THE DRAWINGS

The present disclosure is further described in the detailed description which follows, about the noted plurality of drawings, by way of non-limiting examples of exemplary embodiments of the present disclosure, in which characters represent like elements throughout the several views of the drawings.

FIG. 1 illustrates an exemplary computer system for managing execution of instances in a computing environment, in accordance with an exemplary embodiment of the present disclosure.

FIG. 2 illustrates an exemplary diagram of a network environment for managing execution of instances in a computing environment, in accordance with an exemplary embodiment of the present disclosure.

FIG. 3 illustrates an exemplary system for managing execution of instances in a computing environment, in accordance with an exemplary embodiment of the present disclosure.

FIG. 4 illustrates an exemplary method flow diagram for managing execution of instances in a computing environment, in accordance with an exemplary embodiment of the present disclosure.

FIG. 5 illustrates an exemplary architecture of a system for managing execution of instances in a computing environment, in accordance with an embodiment of the present disclosure.

### DETAILED DESCRIPTION

Exemplary embodiments now will be described with reference to the accompanying drawings. The invention may, however, be embodied in many different forms and should not be construed as limited to the embodiments set forth herein; rather, these embodiments are provided so that this invention will be thorough and complete, and will fully convey its scope to those skilled in the art. The terminology used in the detailed description of the particular exemplary embodiments illustrated in the accompanying drawings is not intended to be limiting. In the drawings, like numbers refer to like elements.

The specification may refer to “an”, “one” or “some” embodiment(s) in several locations. This does not necessarily imply that each such reference is to the same embodiment(s), or that the feature only applies to a single embodiment. Single features of different embodiments may also be combined to provide other embodiments.

As used herein, the singular forms “a”, “an” and “the” are intended to include the plural forms as well, unless expressly stated otherwise. It will be further understood that the terms “include”, “comprises”, “including” and/or “comprising” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to herein as being “connected” or “coupled” to another element, it can be directly connected or coupled to the other element or intervening elements may be present. Furthermore, “connected” or “coupled” as used herein may include wirelessly connected or coupled. As used herein, the term “and/or” may include any and all combinations and arrangements of one or more of the associated listed items. Also, as used herein, the phrase “at least one” means and includes “one or more” and such phrases or terms can be used interchangeably.

Unless otherwise defined, all terms (including technical and scientific terms) used herein have the same meaning as commonly understood by one of the ordinary skills in the art to which this invention pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The figures depict a simplified structure only showing some elements and functional entities, all being logical units whose implementation may differ from what is shown. The connections shown are logical connections and the actual physical connections may be different.

In addition, all logical units and/or controllers described and depicted in the figures may include the software and/or hardware components required for the unit to function. Further, each unit may comprise within itself one or more components, which are implicitly understood. These components may be operatively coupled to each other and be configured to communicate with each other to perform the function of the said unit.

In the following description, for the purposes of explanation, numerous specific details have been set forth in order to provide a description of the disclosure. It will be apparent, however, that the invention may be practiced without these specific details and features.

Through one or more of its various aspects, embodiments and/or specific features or sub-components of the present disclosure, are intended to bring out one or more of the advantages as specifically described above and noted below.

The examples may also be embodied as one or more non-transitory computer-readable medium having instructions stored thereon for one or more aspects of the present technology as described and illustrated by way of the examples herein. The instructions in some examples may include executable code that, when executed by one or more processors, causes the processors to carry out steps necessary to implement the methods of the examples of this technology that are described and illustrated herein.

Existing systems for managing instances in computing environments face significant drawbacks that hinder operational efficiency and resource optimization. Many rely on hardcoded schedules, leading to inflexible management that cannot adapt to changing project demands. Additionally, scheduling is often based on intuition rather than data-driven insights, resulting in inconsistent and inaccurate estimations that vary between teams. The use of generic thresholds for resource allocation fails to account for the unique requirements of individual applications, causing inefficiencies and performance issues. Furthermore, the challenges of coordinating schedules among distributed teams complicates communication and decision-making, exacerbating difficulties in timely project execution. These limitations highlight the urgent need for a more sophisticated approach to instance management that enhances accuracy and collaboration, reduces testing, and reduces electrical power from instances that would otherwise remain active when they are not needed.

The present provides a method and system for managing execution of instances in a computing environment. In the present disclosure, the system first collects a set of data associated with a plurality of instances for a predefined period from a plurality of sources. The system further identifies a historical usage of the plurality of instances based on an analysis of the set of data. The system further generates, using a trained model, a set of configurations for at least one instance from the plurality of instances based on the identified historical usage in accordance with a set of predefined criteria. Thereafter, the system executes the at least one instance based on the set of configurations to manage the at least one instance in the computing environment.

The present disclosure provides technical solutions to the technical problems of traditional methods. The disclosed method enables efficient management of instances by achieving dynamic allocation of instances based on their historical usage patterns and predefined criteria. This allows organizations to manage resources in a better way, resulting in enhanced performance and stability. By effectively managing resources or instances, the organizations can reduce operational costs, especially in cloud environments. The disclosed method ensures that each instance is optimized for performance, leading to faster response times and better user experiences. The disclosed method further allows instances to scale up or down dynamically based on real-time workload demands, ensuring that the system can handle varying loads without compromising performance. Overall, starting and stopping the instances per the timing of the configuration set reduces computer resource and electrical power consumption as compared to leaving the instances is an always active state or a less efficient manually scheduled state.

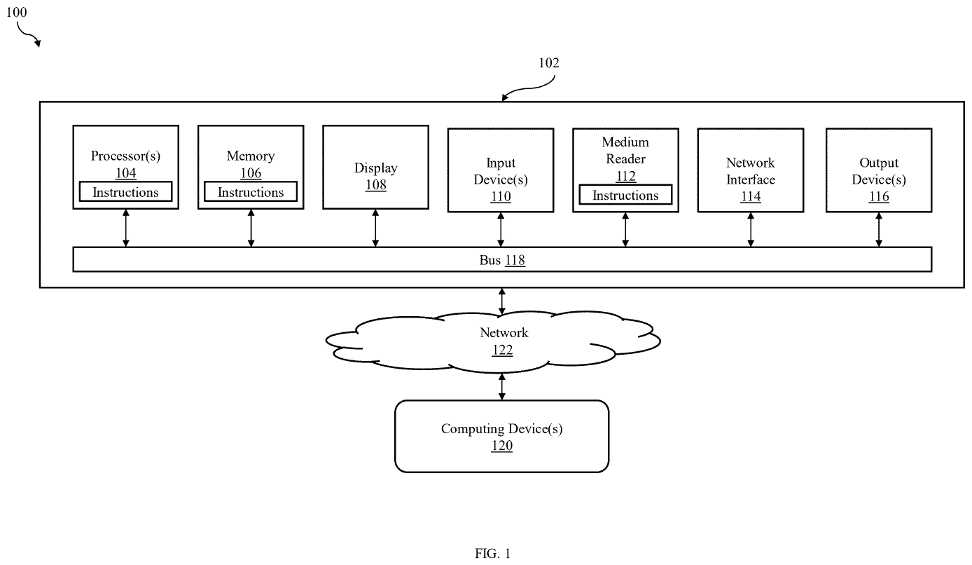

FIG. 1 is an exemplary system for use in accordance with the embodiments described herein. The system 100 is generally shown and may include a computer system 102 which is generally indicated. The term “computer system” may also be referred to herein as “computing device” and such phrases/terms can be used interchangeably in the specifications.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks, or cloud-based environments. Even further, the instructions may be operative in such a cloud-based computing environment.

In a networked deployment, the computer system 102 may operate in the capacity of a server or as a client-user computer in a server-client user network environment, a client-user computer in a cloud-based computing environment, or as a peer-to-peer (or distributed) network environment. The computer system 102, or portions thereof, may be implemented as, or incorporated into, various devices, such as a personal computer, a virtual desktop computer, a tablet computer, a set-top box, a personal digital assistant, a mobile device, a palmtop computer, a laptop computer, a desktop computer, a communications device, a wireless smartphone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application-specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that may include discrete gate and/or transistor logic. The processor 104 may be a central processing unit (CPU), a graphics processing unit (GPU), or both. Additionally, any processor described herein may include multiple processors, parallel processors, or both. Multiple processors may be included in or coupled to, a single device or multiple devices.

The computer system 102 may also include a computer memory 106. The computer memory 106 may include a static memory, a dynamic memory, or both in communication. Memories described herein are tangible storage mediums that can store data and executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article about manufacturing and/or machine components. Memories described herein are computer-readable mediums from which data and executable instructions can be read by a computer. Memories, as described herein, may be random access memory (RAM), read-only memory (ROM), flash memory, electrically programmable read-only memory (EPROM), electrically erasable programmable read-only memory (EEPROM), registers, a hard disk, a cache, a removable disk, tape, compact disk read-only memory (CD-ROM), digital versatile disk (DVD), floppy disk, Blu-ray disk, or any other form of storage medium known in the art. Memories may be volatile or non-volatile, secure and/or encrypted, unsecure and/or unencrypted. As regards the present disclosure, the computer memory 106 may comprise any combination of memories or a single storage.

The computer system 102 may further include a display unit 108, such as a liquid crystal display (LCD), an organic light emitting diode (OLED), a flat panel display, a solid-state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote-control device having a wireless keypad, a microphone coupled to a speech recognition engine, a camera such as a video camera or still camera, a cursor control device, a global positioning system (GPS) device, an altimeter, a gyroscope, an accelerometer, a proximity sensor, or any combination thereof. Those skilled in the art will appreciate that various embodiments of the computer system 102 may include multiple input devices 110. Moreover, those skilled in the art will further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g., software, from any of the memories described herein. The instructions, when executed by a processor 104, can be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software, or any combination thereof which are commonly known and understood as being included with or within a computer system, such as, but not limited to, a network interface 114 and an output device 116. The output device 116 may include but is not limited to, a speaker, an audio out, a video out, a remote-controlled output, a printer, or any combination thereof. Additionally, the term “Network interface” may also be referred to herein as “Communication interface” and such phrases/terms can be used interchangeably in the specifications.

Each of the components of the computer system 102 may be interconnected and communicate via a bus 118 or other communication link. As shown in FIG. 1, the components may be interconnected and communicate via an internal bus. However, those skilled in the art will appreciate that any of the components may also be connected via an expansion bus. Moreover, the bus 118 may enable communication via any standard or other specification commonly known and understood such as, but not limited to, peripheral component interconnect, peripheral component interconnect expresses, parallel advanced technology attachment, serial advanced technology attachment, etc.

The computer system 102 may be in communication with one or more additional computing devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near-field communication, ultra-band, or any combination thereof. Those skilled in the art will appreciate that additional networks 122 which are known and understood may additionally or alternatively be used and that the exemplary networks 122 are not limiting or exhaustive. Also, while the network 122 is shown in FIG. 1 as a wireless network, those skilled in the art will appreciate that the network 122 may also be a wired network.

An additional computing device 120 is shown in FIG. 1 as a personal computer. However, those skilled in the art will appreciate that, in alternative embodiments of the present application, the computing device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Those skilled in the art will appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art will similarly understand that the device may be any combination of devices and apparatuses.

Those skilled in the art will appreciate that the above-listed components of the computing system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor 104 described herein may be used to support a virtual processing environment.

As described herein, various embodiments provide methods and systems for managing execution of instances in a computing environment.

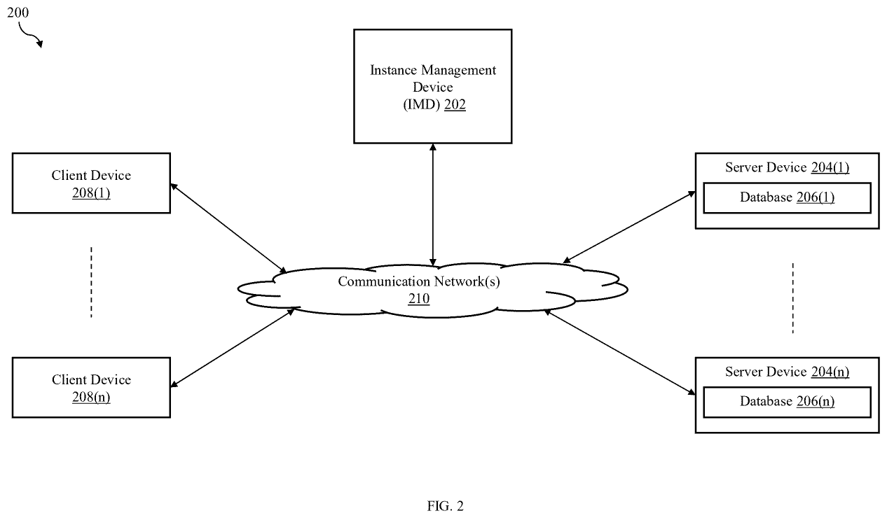

Referring to FIG. 2, a schematic of an exemplary network environment 200 for implementing a method for managing execution of instances in a computing environment, the method is executable on any networked computer platform, such as, for example, a personal computer (PC).

The method for managing execution of instances in a computing environment may be executed by an instance management device (IMD) 202. The IMD 202 may be the same or similar to the computer system 102 as described with respect to FIG. 1. The IMD 202 may store one or more applications that may include executable instructions that, when executed by the IMD 202, cause the IMD 202 to perform desired actions, such as to transmit, receive, or otherwise process various instances, for example, and to perform other actions described and illustrated below with reference to the figures. The application(s) may be implemented as modules or components of other applications. Further, the application(s) may be implemented as operating system extensions, modules, plugins, or the like.

In a non-limiting example, the application(s) may be operative in a cloud-based computing environment. The application(s) may be executed within or as a virtual machine(s) or virtual server(s) that may be managed in a cloud-based computing environment. Also, the application(s), and even the IMD 202 itself, may be located in the virtual server(s) running in a cloud-based computing environment rather than being tied to one or more specific physical network computing devices. Also, the application(s) may be running in one or more virtual machines (VMs) executing on the IMD 202. Additionally, in one or more embodiments of this technology, virtual machine(s) running on the IMD 202 may be managed or supervised by a hypervisor.

In the network environment 200 of FIG. 2, the IMD 202 is coupled to a plurality of server devices 204(1)-204(n) that hosts a plurality of databases 206(1)-206(n), and also to a plurality of client devices 208(1)-208(n) via communication network(s) 210. A communication interface of the IMD 202, such as the network interface 114 of the computer system 102 of FIG. 1, operatively couples and communicates between the IMD 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the IMD 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides several advantages including methods, non-transitory computer-readable media, and IMDs that efficiently implement the method for managing execution of instances in a computing environment.

By way of example only, the communication network(s) 210 may include local area network(s) (LAN(s)) or wide area network(s) (WAN(s)) and can use transmission control protocol/internet protocol (TCP/IP) over Ethernet and industry-standard protocols, although other types and/or numbers of protocols and/or communication networks may be used. The communication network(s) 210 in this example may employ any suitable interface mechanisms and network communication technologies including, for example, tele traffic in any suitable form (e.g., voice, modem, and the like), public switched telephone networks (PSTNs), ethernet-based packet data networks (PDNs), combinations thereof, and the like.

The IMD 202 may be a standalone device or integrated with one or more other devices or apparatuses, such as one or more of the server devices 204(1)-204(n), for example. In one particular example, the IMD 202 may include or be hosted by one of the server devices 204(1)-204(n), and other arrangements are also possible. Moreover, one or more of the devices of the IMD 202 may be in a same or a different communication network including one or more public, private, or cloud-based networks.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. In an example, the server devices 204(1)-204(n) may process requests received from the IMD 202 via the communication network(s) 210 according to the hypertext transfer protocol (HTTP)-based and/or JavaScript object notation (JSON) protocol, for example, although other protocols may also be used.

The server devices 204(1)-204(n) may be hardware or software or may represent a system with multiple servers in a pool, which may include internal or external networks. The server devices 204(1)-204(n) host the databases or repositories 206(1)-206(n) that are configured to store a set of data and a set of configurations for at least one instance.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a controller/agent approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to-peer architecture, virtual machines, or within a cloud-based architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the IMD 202 via communication network(s) 210. Accordingly, the client devices 208(1)-208(n) may be mobile computing devices, desktop computing devices, laptop computing devices, tablet computing devices, or the like, that host chat, e-mail, or voice-to-text applications, for example. In an exemplary implementation, at one client device 208 is a wireless mobile communication device, e.g., a smartphone.

The client devices 208(1)-208(n) may run interface applications, such as standard web browsers or standalone client applications, which may provide an interface to communicate with the IMD 202 via the communication network(s) 210 in order to communicate user requests and information. The client devices 208(1)-208(n) may further include, among other features, a display device, such as a display unit or touchscreen, and/or an input device, such as a keyboard, for example.

Although the exemplary network environment 200 with the IMD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the IMD 202, the server devices 204(1)-204(n), or the client devices 208(1)-208(n), for example, may be configured to operate as virtual instances on the same physical machine. In other words, one or more of the IMD 202, the server devices 204(1)-204(n), or the client devices 208(1)-208(n) may operate on the same physical device rather than as separate devices communicating through communication network(s) 210. Additionally, there may be more or fewer IMDs 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication, may also be implemented, as desired, to increase the robustness and performance of the devices and systems of the examples. The examples may also be implemented on computer system(s) that extend across any suitable network using any suitable interface mechanisms and traffic technologies, including by way of example only tele traffic in any suitable form (e.g., voice and modem), wireless traffic networks, cellular traffic networks, packet data networks (PDNs), the Internet, intranets, and combinations thereof.

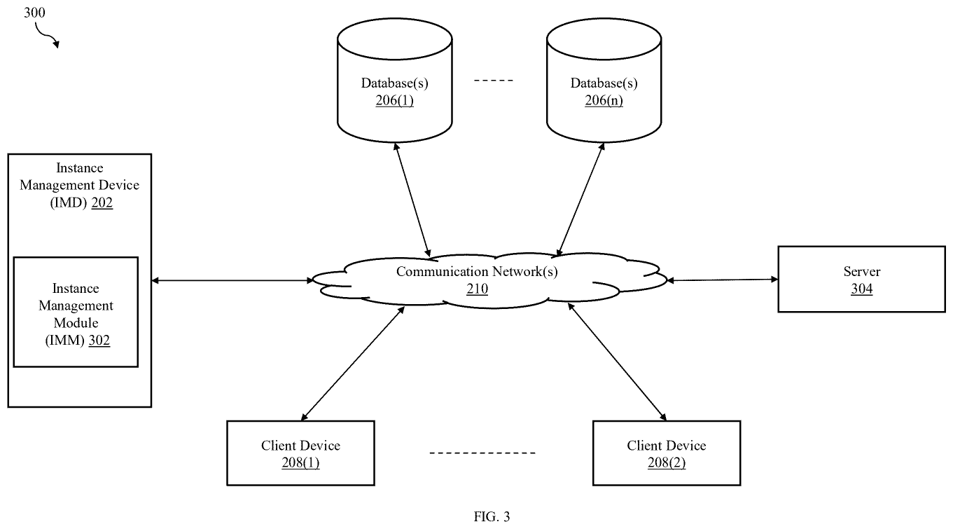

FIG. 3 illustrates an exemplary system for implementing a method for managing execution of instances in a computing environment, in accordance with an exemplary embodiment. As illustrated in FIG. 3, the system 300 may include an instance management device (IMD) 202 within which an instance management module (IMM) 302 is embedded, a server 304, a database(s) 206(1) . . . 206(n), a plurality of client devices 208(1) . . . 208(2), and a communication network(s) 210.

According to exemplary embodiments, the system 300 may comprise the instance management device (IMD) 202 including the IMM 302 may be connected to the server 304 and the database(s) 206(1) . . . 206(n) via the communication network(s) 210, but the disclosure is not limited thereto. The IMD 202 may also be connected to the plurality of client devices 208(1) . . . 208(2) via the communication network(s) 210, but the disclosure is not limited thereto. The database(s) 206(1) . . . 206(n) may include rule database.

In an embodiment, the IMD 202 as described and shown in FIG. 3 includes the IMM 302, although it may include other rules, policies, modules, databases, or applications, for example. As will be described below, the IMM 302 is configured to carry out a method for managing execution of instances in a computing environment.

An exemplary system 300 for implementing a mechanism to provide them for managing execution of instances in a computing environment by utilizing the network environment of FIG. 2 is shown as being executed in FIG. 3. Specifically, a first client device 208(1) and a second client device 208(2) are illustrated as being in communication with the IMD 202. In this regard, the first client device 208(1) and the second client device 208(2) may be “clients” of the IMD 202 and are described herein as such. Nevertheless, it is to be known and understood that the first client device 208(1) and/or the second client device 208(2) need not necessarily be “clients” of the IMD 202, or any entity described in association therewith herein. Any additional or alternative relationship may exist between either or both of the first client device 208(1) and the second client device 208(2) and the IMD 202, or no relationship may exist.

Further, the IMD 202 is illustrated as being able to access one or more databases 206(1) . . . 206(n). The IMM 302 may be configured to access these repositories/databases for implementing a for managing execution of instances in a computing environment. In some embodiment, the server 304 may be the same or equivalent to the server device 204 as illustrated in FIG. 2.

The first client device 208(1) may be, for example, a smartphone. The first client device 208(1) may be any additional device described herein. The second client device 208(2) may be, for example, a personal computer (PC). The second client device 208(2) may also be any additional device described herein.

The process may be executed via the communication network(s) 210, which may comprise plural networks as described above. For example, in an exemplary embodiment, either or both the first client device 208(1) and the second client device 208(2) may communicate with the IMD 202 via broadband or cellular communication. These embodiments are merely exemplary and are not limiting or exhaustive.

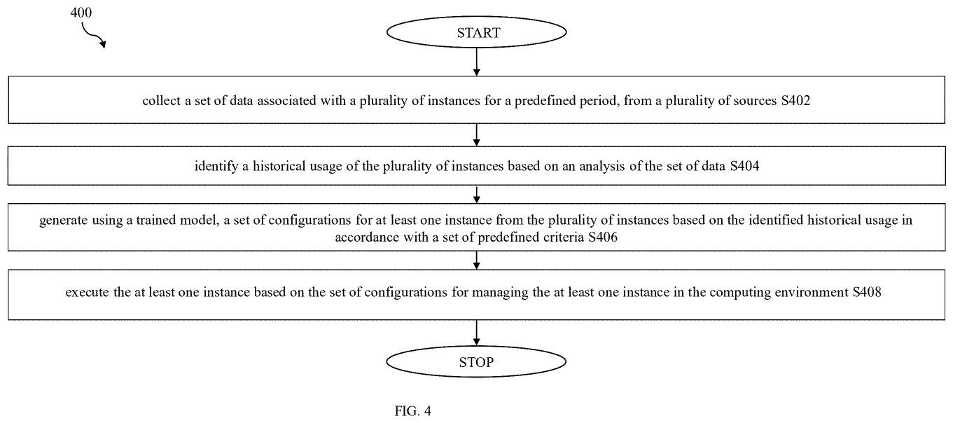

Referring to FIG. 4, an exemplary method 400 is shown for managing execution of instances in a computing environment, in accordance with an exemplary implementation.

As shown in FIG. 4, the method 400 begins following a need to optimize resources of an organization by managing efficient utilization of various instances. The method 400 is implemented by at least one processor 104.

At step S402, the method 400 includes collecting, by the at least one processor 104, a set of data associated with a plurality of instances for a predefined period, from a plurality of sources.

In an exemplary embodiment, the set of data may include at least one from among central processing unit (CPU) usage reports, memory usage reports, shift details, a list of holidays, a code freeze period, and task descriptions. The predefined period refers to a time frame that has been set or established in advance, often for specific tasks, events or processes. The plurality of sources may include an issue tracking tool, databases, application programming interfaces (APIs), and data collected from internet of things (IOT) devices.

The CPU usage reports may show how much of the CPU's processing power is being utilized by an instance at a given time. CPU usage is typically measured as a percentage, where 100% indicates full utilization. This data helps in monitoring previous usage of each instance during the predefined period and diagnosing potential bottlenecks or inefficiencies.

The memory usage reports for instance may provide insights into how much memory is being consumed by a particular instance. It is to be noted that in cloud environments, each instance has a fixed amount of memory allocated, and tracking memory usage can ensure that the instance is not overutilized (leading to performance degradation) or underutilized.

The shift details may refer to scheduled operations or maintenance periods for instance. For example, if an application is running on multiple instances in a data center or cloud, there is a scheduled maintenance or software update during certain shifts (e.g., times of day when certain teams are on duty). In this case, the shift details provide information about availability of resources/instances. The code freeze period refers to a period where no new changes are made to the application code, ensuring stability for release. For example, during a code freeze period, testing cycle/window reduces within an organization and thus usage of instances reduces in a lower environment. In general, the lower environment refers to a stage during development, testing, or quality checks related to a software or a code. During scheduled maintenance shift details, the number of resources are less utilized. For example, during a typical week at a cloud-based e-commerce platform, the operations team during the day shift (8 AM to 4 PM) sees full utilization of server instances to handle peak user traffic, while during the evening shift (4 PM to 12 AM) the usage of instances reduces by 30%. The operation team may plan to run automated tests for stability during the evening shift. Further, on weekends, a scheduled maintenance window from 2 AM to 4 AM ensures that all instances are offline to perform updates, while a code freeze period for the week before a major release, limits any new deployments, optimizing resources in the lower environments for testing. By effectively utilizing this shift information, the company may manage resources better and minimize costs while enhancing performance and stability.

The task descriptions may refer to operational details that need to be performed on specific instances to manage their lifecycle and configuration. For example, task description is basically a user story which is a concise, high-level description of a feature or functionality from the perspective of an end user or a customer.

In an implementation, after collecting the set of data, the method may further include storing, by the at least one processor 104, the set of data into a database for further processing. The method may also include cleaning and preparing the set of data for further analysis.

It is to be noted that cleaning the set of data ensures the quality and accuracy of the analysis. Data cleaning may involve identifying and rectifying errors or inconsistencies (e.g., removing duplicate entries, correcting typographical errors, etc.) within the set of data. In an implementation, the data cleaning may include data transformation, feature selection and extraction, and data integration. The data transformation may involve converting data into a suitable format or structure for analysis. For example, converting text data into numerical values or normalizing data to ensure uniformity. In the data integration, data sourced from multiple sources/databases or formats, is integrated into a cohesive dataset for comprehensive analysis.

At step S404, the method includes identifying, by the at least one processor 104, a historical usage of the plurality of instances based on an analysis of the set of data.

The historical usage of the plurality of instances may include a start time and an end time of each instance. In an implementation, the historical usage may include instance identity, operational status of each instance (e.g., stop, failed, etc.), and location of each instance where it was deployed or executed (e.g., such as physical or virtual location, or data center specifics).

As used herein, the term “historical usage of the plurality of instances” may refer to a record or a log of past activity for multiple instances (e.g., virtual machines, containers, or services). These instances could be running on cloud platforms (e.g., amazon web service (AWS®), Google Cloud®, etc.) or in on-premises data centers. The start time and end time of each instance tracks when each instance was launched and when it was terminated or stopped. For example, the historical usage data may disclose that a particular instance was active for 5 hours on a specific day, consuming 60% of its CPU capacity and 70% of its memory.

In an implementation, the at least one processor 104 may identify the historical usage of the plurality of instances based on the analysis of the set of data using machine learning algorithms.

At step S406, the method includes generating, by the at least one processor 104 using a trained model, a set of configurations for at least one instance from the plurality of instances based on the identified historical usage in accordance with a set of predefined criteria. The set of configurations includes at least one from among an estimated start time and an end time for the at least one instance, estimation of possible public holidays and code freeze periods.

In an implementation, the method may employ a machine learning model or a statistical model that has been trained on the historical usage of the plurality of instances. This model learns patterns and relationships within the set of data that can be applied to make predictions or generate recommendations about estimation of start and stop times for instances, public holidays, code freeze periods and also manage horizontal scaling of instances.

For example, components/instances used in the historical usage are read using the trained model to understand the start and stop time for each of those components/instances. The trained model may be configured to analyze the task description, extract important keywords from the task description and identify the components that are required to achieve the acceptance criteria of the task description. This way the trained model predicts the output for each instance whenever it is used in the future.

In an implementation, the set of configurations may include project/resource specific details to handle the running time of specific instances/resources.

In an implementation, the identified historical usage of the plurality of instances based on the analysis of the set of data may be a time series data, which may be further used by the trained model to generate the set of configurations as described above.

At step S408, the method includes executing, by the at least one processor 104, the at least one instance based on the set of configurations for managing instances in the computing environment.

For example, the at least one processor 104 further feeds the generated set of configurations into a start and stop service in order to execute the at least one instance and manage instances in the computing environment. The generated set of configurations may include a start and/or a stop time for the instance, and the start service can start the instance at the start time and/or stop the instance at the stop time.

In an implementation, the trained model may be integrated with a project management tool to evaluate an impacted set of instances from the plurality of instances. The project management tool is used to manage instances in the computing environment.

The examples and embodiments described herein are for illustrative purposes only and are not intended to limit the scope of the invention. Variations and modifications that fall within the spirit and scope of the invention are included. References to prior art do not imply any endorsement or rejection as part of the claimed invention.

An example of a set of configurations is provided as follows:

{
resourceType: “EC2”,
start_datetime: [“04-10-2024,8:30”,“04-10-2024,8:30”],
stop_datetime: [“04-10-2024,8:30”,“04-10-2024,8:30”],
region: [US-EAST-1],
project: [Reconciliation]
}

Thereafter, the method 400 stops.

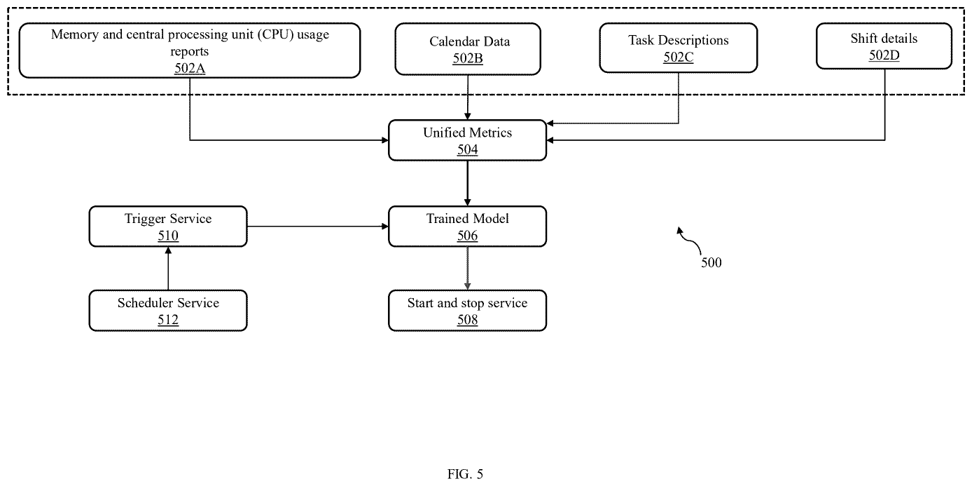

FIG. 5 illustrates an exemplary architecture 500 of a system for managing execution of instances in a computing environment, in accordance with an embodiment of the present disclosure.

At 502, the system collects a set of data associated with a plurality of instances for a predefined period. The set of data may include central processing unit usage reports and memory usage reports 502a, calendar data 502b (e.g., holiday calendar), a code freeze period, task descriptions 502c (e.g., back data from a Jira®board), and shift details 502d.

At 504, the system forms unified metrics 504 based upon the collected set of data. Further, at least one processor 104 of the system identifies a historical usage of the plurality of instances based on an analysis of the set of data. The historical usage of the plurality of instances includes a start time and an end time of each instance.

Furthermore, a trained model 506 (e.g., seasonal auto-regressive integrated moving average (SARIMA) model) analyzes the unified metrics 504 and generates a set of configurations for at least one instance from the plurality of instances based on the identified historical usage in accordance with a set of predefined criteria. In an implementation, the unified metrics 504 may represent a time series data. The trained model 506 may be trained based on the historical usage of the plurality of instances. The trained model 506 may be further configured to realize historical application or instance runtime and usage details. The set of configurations includes at least one from among a start time and an end time for the at least one instance, estimation of possible holidays and code freeze periods.

Further, the generated set of configurations may be provided with a start and stop service 508 to execute the at least one instance based on the set of configurations to manage instances in the computing environment. The start and stop service 508 has its own standards and templates. In an implementation, a scheduler service 512 which is an external or cloud vendor-specific service, may help schedule and trigger an activity (e.g., start/stop) on a regular basis. The scheduler service 512 causes a trigger service 510 to trigger the evaluation process and acts as the trigger point to execute the at least one instance. This way the system performs efficient management of instances in the computing environment while reducing overall power consumption to confine instances to only those times that they are specifically needed.

In an implementation, the trained model 506 may be integrated with a project management tool to evaluate an impacted set of instances from the plurality of instances in the computing environment.

The present disclosure provides technical solutions to the technical problems of traditional methods. The disclosed method enables efficient management of instances by achieving dynamic allocation of instances based on their historical usage patterns and predefined criteria. This allows organizations to manage resources in a better way, resulting in enhanced performance and stability. By effectively managing resources or instances, the organizations can reduce operational costs, especially in cloud environments. The disclosed method ensures that each instance is optimized for performance, leading to faster response times and better user experiences. The disclosed method further allows instances to scale up or down dynamically based on real-time workload demands, ensuring that the system can handle varying loads without compromising performance. Overall, starting and stopping the instances per the timing of the configuration set reduces computer resources and electrical power consumption as compared to leaving the instances is an always active state or a less efficient manually scheduled state.

Although the invention has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the invention has been described with reference to particular means, materials, and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The terms “computer-readable medium” and “computer-readable storage medium” shall also include any medium that is capable of storing, encoding, or carrying a set of instructions for execution by a processor 104 or that causes a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tape, or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application-specific integrated circuits, programmable logic arrays, and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

According to an aspect of the present disclosure, a non-transitory computer-readable storage medium storing instructions to manage execution of instances in a computing environment is disclosed. The instructions include executable code which, when executed by a processor 104, may cause the processor 104 to collect a set of data associated with a plurality of instances for a predefined period from a plurality of sources; identify historical usage of the plurality of instances based on analysis of the set of data; generate, using a trained model, a set of configurations for at least one instance out of the plurality of instances based on the identified historical usage in accordance with a set of predefined criteria; and execute the at least one instance based on the set of configurations to manage instances in the computing environment.

Although the present specification describes components and functions that may be implemented in particular embodiments with reference to particular standards and protocols, the disclosure is not limited to such standards and protocols. Such standards are periodically superseded by faster or more efficient equivalents having the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The abstract of the disclosure is submitted with the understanding that it will not be used to interpret or limit the scope or meaning of the claims. In addition, in the foregoing detailed description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, the inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

We claim:

1. A method for managing execution of instances in a computing environment, the method being implemented by at least one processor, the method comprising:
collecting, by the at least one processor, a set of data associated with a plurality of instances for a predefined period, from a plurality of sources;
identifying, by the at least one processor, a historical usage of the plurality of instances based on an analysis of the set of data;
generating, by the at least one processor using a trained model, a set of configurations for at least one instance from the plurality of instances based on the identified historical usage in accordance with a set of predefined criteria; and
executing, by the at least one processor, the at least one instance based on the set of configurations for managing the at least one instance in the computing environment.

2. The method as claimed in claim 1, wherein the set of data comprises at least one from among central processing unit usage reports, memory usage reports, shift details, a list of holidays, a code freeze period, and task descriptions.

3. The method as claimed in claim 1, wherein the historical usage of the plurality of instances comprises a start time and an end time of each instance.

4. The method as claimed in claim 1, wherein the model is trained based on the historical usage of the plurality of instances.

5. The method as claimed in claim 1, wherein the set of configurations comprises at least one from among an estimated start time and an end time for the at least one instance, estimation of possible holidays and code freeze periods.

6. The method as claimed in claim 1, wherein the set of configurations includes a start time and a stop time, and the executing the at least one instance further comprises for a particular instance:
starting the particular instance at the start time; and
stopping the particular instance at the stop time.

7. The method as claimed in claim 1, wherein the trained model is integrated with a project management tool to evaluate an impacted set of instances from the plurality of instances.

8. A computing device configured for managing execution of instances in a computing environment, the computing device comprising:
at least one processor;
a memory storing instructions; and
a communication interface coupled to each of the at least one processor and the memory, wherein the processor is programmed to cooperate with the instructions to perform operations comprising:
collect a set of data associated with a plurality of instances for a predefined period from a plurality of sources;
identify a historical usage of the plurality of instances based on an analysis
of the set of data;
generate, using a trained model, a set of configurations for at least one instance from the plurality of instances based on the identified historical usage in accordance with a set of predefined criteria; and
execute the at least one instance based on the set of configurations to manage the at least one instance in the computing environment.

9. The computing device as claimed in claim 8, wherein the set of data comprises at least one from among central processing unit usage reports, memory usage reports, shift details, a list of holidays, a code freeze period, and task descriptions.

10. The computing device as claimed in claim 8, wherein the historical usage of the plurality of instances comprises a start time and an end time of each instance.

11. The computing device as claimed in claim 8, wherein the model is trained based on the historical usage of the plurality of instances.

12. The computing device as claimed in claim 8, wherein the set of configurations comprises at least one from among an estimated start time and an end time for the at least one instance, estimation of possible holidays and code freeze periods.

13. The computing device as claimed in claim 8, wherein the set of configurations includes a start time and a stop time, and the execute the at least one instance further comprises for a particular instance:
starting the particular instance at the start time; and
stopping the particular instance at the stop time.

14. The computing device as claimed in claim 8, wherein the trained model is integrated with a project management tool to evaluate an impacted set of instances from the plurality of instances.

15. A non-transitory computer readable storage medium storing instruction for managing execution of instances in a computing environment, the instructions comprising executable code which when executed by a processor, causes the processor to perform operations comprising:
collect a set of data associated with a plurality of instances for a predefined period from a plurality of sources;
identify a historical usage of the plurality of instances based on an analysis of the set of data;
generate, using a trained model, a set of configurations for at least one instance from the plurality of instances based on the identified historical usage in accordance with a set of predefined criteria; and
execute the at least one instance based on the set of configurations to manage the at least one instance in the computing environment.

16. The storage medium as claimed in claim 15, wherein the set of data comprises at least one from among central processing unit usage reports, memory usage reports, shift details, a list of holidays, a code freeze period, and task descriptions.

17. The storage medium as claimed in claim 15, wherein the historical usage of the plurality of instances comprises a start time and an end time of each instance.

18. The storage medium as claimed in claim 15, wherein the model is trained based on the historical usage of the plurality of instances.

19. The storage medium as claimed in claim 15, wherein the set of configurations comprises at least one from among an estimated start time and an end time for the at least one instance, estimation of possible holidays and code freeze periods.

20. The storage medium as claimed in claim 15, wherein the set of configurations includes a start time and a stop time, and the execute the at least one instance further comprises for a particular instance:
starting the particular instance at the start time; and
stopping the particular instance at the stop time.
